(19) United States
(12) Patent Application Publication
(10) Pub. No.: US 2017/0300164 A1
(43) Pub. Date: Oct. 19, 2017

(54) MACHINE TOOL AND USE OF A TOUCH-SENSITIVE DISPLAY FOR DRIVING A MACHINE PART OF A MACHINE TOOL

(71) Applicant: J.G. Weisser Sohne GmbH & Co. KG, St. Georgen (DE)

(72) Inventor: Thorsten Rettich, Konigsfeld (DE)

(73) Assignee: J.G. Weisser Sohne GmbH & Co. KG, St. Georgen (DE)

(21) Appl. No.: 15/284,813

(22) Filed: Oct. 4, 2016

(30) Foreign Application Priority Data
Apr. 16, 2016 (DE) 102016004630.9

(51) Int. Cl. G06F 3/041; G06F 3/0488

(52) U.S. Cl. CPC G06F 3/0416; G06F 3/04883; G06F 3/0412; G06F 2203/04808; G06F 2203/04105

(57) ABSTRACT

According to the invention, it is provided that, on a machine tool (1) which has a machine part (2) which can be adjusted by motor, a touch-sensitive display (4) is used to display the machine part (2) in its instantaneous state on the display (4) and to adjust said machine part by motor by a swiping gesture being executed on the display (4). The objective of this is to simplify operator control of the machine tool (1).

### INCORPORATION BY REFERENCE

The following documents are incorporated herein by reference as if fully set forth: German Patent Application No. 102016004630.9, filed Apr. 16, 2016.

### BACKGROUND

The invention relates to a machine tool comprising a machine part, which can be adjusted by motor, in particular in a mechanical and/or electromechanical and/or pneumatic and/or hydraulic manner, and to the use of a touch-sensitive display for driving a machine part, which can be adjusted by motor, of a machine tool of this kind.

Machine tools of this kind are provided with drive units with which machine parts, which can be adjusted by motor, of these machine tools can be adjusted in a targeted manner. To date, levers, buttons or other switching areas have been used for driving purposes, corresponding control signals being transmitted from the drive unit to the respective machine part which is to be adjusted when said levers, buttons or other switching areas are operated. In order to be able to adjust the machine part which can be adjusted by motor with the required degree of precision, a certain amount of experience or a certain routine is required by the user of the machine tool in the process. Since the user of the machine tool generally does not receive any feedback in respect of the adjustment made, it is expedient when the user of the machine tool can make visual contact with the machine part which can be adjusted by motor and which said user is operating. This can involve a certain degree of difficulty, particularly when there is a large distance between the user of the machine tool and the machine part which is to be adjusted by motor or else when said distance is comparatively small.

### SUMMARY

The object of the invention is therefore to provide a machine tool of the kind mentioned in the introductory part which provides an alternative operator control concept in comparison to the prior art, which alternative operator control concept can avoid the disadvantages outlined above.

This object is achieved by a machine tool having one or more features of the invention, in particular, by a machine tool which comprises a machine part which can be adjusted by motor and comprises a touch-sensitive display, where a drive unit of the machine tool is designed to illustrate the machine part in its instantaneous state on the display and to adjust the machine part depending on a swiping gesture which is executed on the display.

In this way, the desired adjustment of the machine part which can be adjusted by motor can be performed in a more intuitive manner in comparison to the previously known operator control concepts. In addition, the operator of the machine tool receives direct feedback in respect of the adjustment made by means of the display on which the instantaneous state of the machine part is shown. The machine part can be adjusted in a particularly intuitive manner since the user or operator of the machine tool is provided with a virtual image of the machine part, which can be adjusted by motor, on the display and said user or operator can touch said virtual image on the display and can move, that is to say adjust, said image in a desired manner by moving his hands on or relative to the display. This adjustment movement, which the user or operator of the machine tool executes using one or both hands or else individual fingers of a hand or both hands on the display, is transmitted by the drive unit for adjusting the machine part, which can be adjusted by motor, at least indirectly to said machine part. In this way, it is now possible to pre-specify an adjustment movement, which previously had to be controlled by operating a plurality of buttons, levers or switching areas on an operator control panel of a machine tool, by simple swiping gestures on the display. Operator control of a machine tool of this kind can be simplified as a result.

It may be advantageous when the drive unit is designed to detect a speed of the executed swiping gesture. In this way, the speed of the executed swiping gesture can be associated with an adjustment parameter. Therefore, it is possible to generate a further control signal from the detected speed of the executed swiping gesture. For example, the speed of the executed swiping gesture can be correlated with an adjustment speed of the machine part or with an acceleration of the adjustable machine part.

It may also be expedient when the display is a pressure-sensitive display and the drive unit is designed to detect a pressure intensity of a swiping gesture which is executed on the display. In this way, it is possible to derive an adjustment parameter of the adjustment movement of the adjustable machine part from a pressure which is exerted onto the display when executing the swiping gesture.

If the drive unit is designed to set a speed of the adjustment of the machine part, the movement of the machine part, which is to be adjusted by motor, can be pre-specified by a swiping gesture. The speed with which the adjustment of the machine part, which can be adjusted by motor, is then performed can then be pre-specified by the drive unit. In addition, it is possible for the drive unit to pre-specify different speeds of the adjustment of the machine part for different applications.

In order to allow two-handed and/or two-finger operator control of the machine tool, it may be expedient when the drive unit is designed to detect at least two simultaneous touches on the display. In this connection, it may be particularly preferred when the drive unit is designed to separately detect at least two simultaneous touches on the display. In this way, it is possible to generate one or more control signals depending on a relative movement of the at least two simultaneous touches, which are performed on the display, in relation to one another too. This increases the number of control signals which can be pre-specified by use of the display and as a result the variability of the operator control concept according to the invention.

In one embodiment of the machine tool according to the invention, it can be provided that the machine part has two elements which can move relative to one another. The drive unit can then be designed to trigger relative movement of these elements toward one another or relative to one another by a swiping gesture which executes at least two simultaneous touches on the display. In this way, the variability firstly of the machine tool and secondly of the adjustment movements of the machine part can be increased, this possibly also contributing to even more intuitive operator control of the machine tool.

The machine part can be adjusted in at least two axes. The drive unit can then be designed for separate adjustment in the at least two axes by means of different swiping movements. In this connection, it is particularly advantageous when the different swiping movements are swiping movements which each trace one axis of the at least two axes on the display, preferably in the correct position.

In order to be able to provide at least visual feedback about the adjustment movement of the machine part, which can be adjusted by motor, to the operator, it may be expedient when the drive unit is designed to calculate a preferably correctly positioned illustration of an instantaneous state of the machine part on the basis of a measurement signal from at least one sensor. This sensor can be arranged, for example, in, on or adjacent to the machine part, which can be adjusted by motor, on the machine tool, preferably within an operating area of the machine tool.

The object mentioned in the introductory part is also achieved by the use, according to the invention, of a touch-sensitive display as described below and in the claims. According to the invention, the use of a touch-sensitive display for driving a machine part, which can be adjusted by motor, of a machine tool, in particular a machine tool as has been described in detail above is provided. It is provided here that the machine part is displayed on the display in its instantaneous state and is adjusted by motor by a swiping gesture being executed on the display.

Expediently, a speed of an adjustment movement can be set depending on a speed of the detected swiping gesture. In this way, the operator or user of the machine tool can pre-specify the speed of the adjustment movement of the machine part, which can be adjusted by motor, depending on the speed with which said operator or user executes the swiping gestures on the display.

The machine part can have two elements which can move relative to one another. In this case, a relative movement of the elements toward one another can be triggered by a swiping gesture which executes at least two simultaneous touches on the display. This can improve intuitive operator control and driving of the machine part, which can be adjusted by motor, by the use of swiping gestures.

Operator control or driving of the machine tool can be made even more convenient for a user when the machine part which is intended to be adjusted can be chosen by selecting the displayed machine part on the display. In this case, the corresponding machine part can be activated for adjustment by the selection on the display, so that swiping gestures which are made on the display with respect to the machine part illustrated there can then be transmitted to the machine part by a drive unit, for example the drive unit already mentioned above, and converted into adjustment movements.

In this case, the machine part can be adjusted in at least two axes separately from one another by different swiping movements which, in particular, each trace one axis of the at least two axes on the display, preferably in the correct position. This allows extremely intuitive operator control of the machine tool.

In order to be able to represent the instantaneous state of the machine part, which can be adjusted by motor, on the display, preferably in real time or with only a negligible delay, it may be expedient when the instantaneous state of the machine part is detected by use of at least one sensor which can be formed on the machine tool. A signal which is generated by the at least one sensor can then be transmitted to the display, for example, by a drive unit, in particular the drive unit already mentioned above, in order to change the illustration of the machine part on the display.

### BRIEF DESCRIPTION OF THE DRAWINGS

An exemplary embodiment of the invention is described in greater detail below with reference to the drawings. In the drawings, in partially highly schematic illustrations:

FIG. 1 shows a block diagram of a machine tool according to the invention, and

FIG. 2 shows a plan view of an operator control unit of a machine tool according to the invention, with a touch-sensitive display in the form of a central operator control element being shown together with a plurality of operator control keys, buttons, switches and levers.

### DETAILED DESCRIPTION OF THE PREFERRED EMBODIMENTS

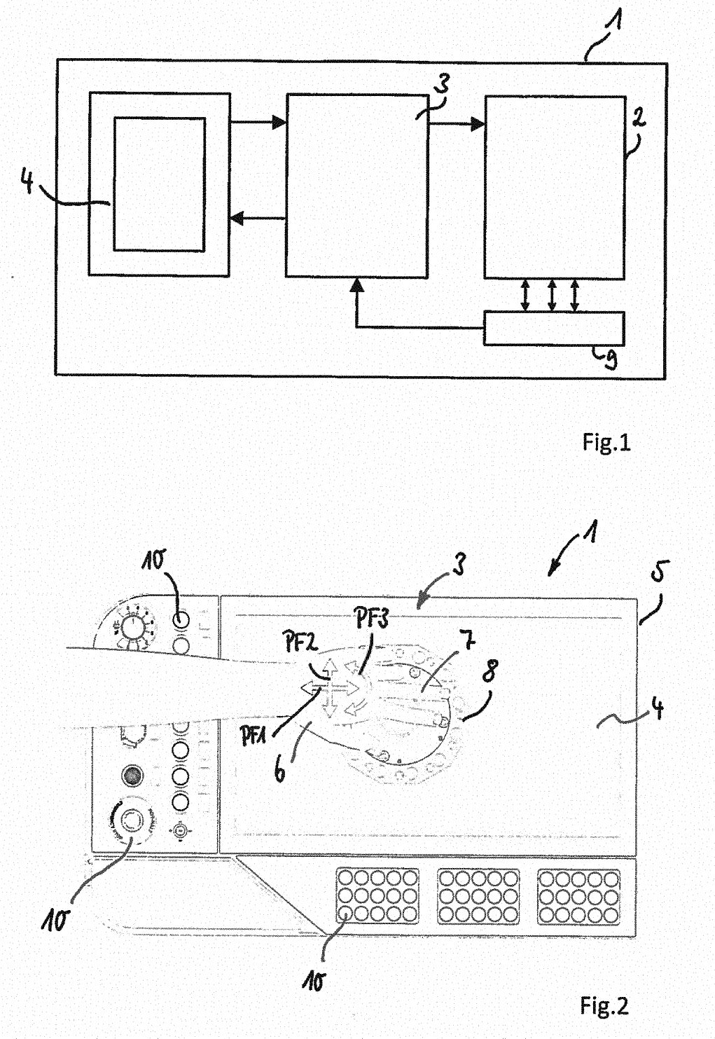

According to FIG. 1, a machine tool, which is denoted 1 overall, has at least one machine part 2 which can be adjusted by motor and which is connected to a drive unit 3 of the machine tool for the purpose of receiving control signals. The machine tool 1 additionally has a touch-sensitive display 4 which is arranged on an operator control console 5 according to FIG. 2. The drive unit 3 is integrated into this operator control console 5.

The drive unit 3 is designed to illustrate the machine part 2 in its instantaneous state on the display 4 and to adjust the machine part 2 depending on a swiping gesture which is executed on the display 4. According to FIG. 2, this swiping gesture, indicated by the double-headed arrows Pf 1 and Pf 2 and Pf 3, can be executed on the display 4 by a hand 6 of an operator of the machine tool 1.

The drive unit 3 is designed to detect a speed of the swiping gesture which is executed on the display 4. The display 4 is a pressure-sensitive display. That is to say, the pressure which is exerted on the display 4 by a swiping gesture which is executed on the display 4 can be detected or determined with the aid of the display 4. The drive unit 3 is designed to detect the pressure intensity of the swiping gesture which is executed on the display 4. In this way, an adjustment parameter of the adjustment movement of the machine part 2 can be derived from the pressure intensity of the swiping gesture on the display 4 and used by the drive unit 3 to drive and move the machine part 2.

As indicated by the double-headed arrows Pf 1, Pf 2, and Pf 3, this swiping gesture can comprise both rectilinear movements and also rotary or pivoting movements or else movements which are executed along a bent movement line on the display 4.

The drive unit 3 is also designed to set a speed of the adjustment of the machine part 2. The drive unit 3 is also designed to separately detect at least two simultaneous touches on the display 4. These at least two simultaneous touches can be executed by means of different fingers 7 of the hand 6 of the user or operator of the machine tool 1 or else by means of two hands or different fingers of two different hands on the display 4. FIG. 2 clearly shows that a virtual image 8 of the machine part 2, which is to be adjusted by motor, is depicted on the display 4 and that the user can “grasp” the virtual image 8 using a hand 6 and individual fingers 7 of the hand 6 and can adjust said virtual image in the desired manner by executing a swiping gesture on the display 4. In the process, the adjustment movement which is executed on the display 4 by the swiping gesture is transmitted to the machine part 2, which is to be adjusted, by the drive unit 3. Here, the arrows which are illustrated between the display 4 and the drive unit 3 and, respectively, between the drive unit 3 and the machine part 2 in FIG. 1 illustrate the flow of data and/or information.

The machine part 2 has two elements which can move relative to one another. The drive unit 3 is designed to trigger a relative movement of these elements toward one another by a swiping gesture which executes at least two simultaneous touches on the display 4.

The machine part 2 can be adjusted in at least two axes. In this case, the drive unit 3 is designed to separately adjust the machine part 2 in the at least two axes by means of different swiping movements which each trace one axis of the at least two axes on the display 4 in the correct position. In this way, the at least two axes of the machine part 2 can be adjusted or driven independently of one another by different swiping movements, for example by means of two different fingers 7 of one hand 6 or by means of two different fingers 7 of two different hands.

The drive unit 3 is additionally designed to calculate a correctly positioned illustration of an instantaneous state of the machine part 2 on the basis of a measurement signal from at least one sensor 9. In this way, the virtual image 8, which is illustrated on the display 4, of the machine part 2 can actually also correspond to the real or instantaneous state of the machine part 2, which can be adjusted by motor, on account of the data obtained from the at least one sensor 9 of the machine tool 1. The arrows which are illustrated between the sensor 9 and the machine part 2 and, respectively, between the sensor 9 and the drive unit 3 in FIG. 1 once again illustrate the flow of data and/or information.

An existing operator control concept, which comprises buttons, levers, switches or similar operator control elements 10, as are also illustrated on the operator control console 5 according to FIG. 2, can be replaced by or supplemented with the use of the touch-sensitive display 4 for driving the machine part 2, which can be adjusted by motor, of the machine tool 1.

The machine part 2 is displayed in its instantaneous state on the display 4. A virtual image 8 of the machine part 2 is displayed in this case. The machine part 2 can be adjusted by motor in the desired manner by executing a swiping gesture on the display 4.

In this case, a speed of an adjustment movement can be set depending on a speed of the detected swiping gesture in at least one drive mode.

The machine part 2 has the two elements which can move relative to one another. A relative movement of the elements toward one another is then triggered by a swiping gesture which executes at least two simultaneous touches on the display 4.

Particularly when the machine tool 1 has a plurality of machine parts 2, the machine part 2 which is intended to be adjusted can be chosen and also activated for adjustment by selecting the illustrated machine part 2 on the display 4.

The machine part 2 is adjusted in at least two axes separately from one another by the use of different swiping movements which each trace one axis of the at least two axes on the display 4 in the correct position (cf. double-headed arrows Pf 1, Pf 2 and Pf 3). As already indicated above, the instantaneous state of the machine part 2 is detected by the at least one sensor 9 (see double-headed arrows between sensor 9 and machine part 2 in FIG. 1). The virtual image 8 of the machine part 2 can then be generated on the display 4 by means of the data which is detected by the at least one sensor 9 and which is transmitted to the drive unit 3. The virtual image 8 of the machine part 2 corresponds to the instantaneous state of the machine part 2, which changes due to the adjustment by motor which is prompted by the swiping gestures which are executed on the display 4.

According to the invention, it is provided that the touch-sensitive display 4 is used on the machine tool, which has a machine part 2 which can be adjusted by motor, to display the machine part 2 in its instantaneous state on the display 4 and to adjust said machine part by motor by executing a swiping gesture on the display 4. Operator control of a machine tool 1 can be simplified as a result.

### LIST OF REFERENCE SYMBOLS

1 Machine tool

2 Machine part

3 Drive unit

4 Display

5 Operator control console

6 Hand

7 Finger

8 Virtual image of 2

9 Sensor

10 Operator control elements

1. A machine tool (1) comprising a machine part (2) that is adjustable by a motor, a touch-sensitive display (4), a drive unit (3) connected to the machine part and the touch-sensitive display, the drive unit being configured to illustrate the machine part (2) in an instantaneous state on the display and to adjust the machine part (2) depending on a swiping gesture which is executed on the display (4).

2. The machine tool as claimed in claim 1, wherein the drive unit (3) is configured to detect a speed of the executed swiping gesture, or the display (4) is a pressure-sensitive display and the drive unit (3) is configured to detect a pressure intensity of a swiping gesture which is executed on the display (4), or both.

3. The machine tool as claimed in claim 2, wherein the drive unit (3) is configured to set a speed for the adjustment of the machine part (2).

4. The machine tool as claimed in claim 1, wherein the drive unit (3) is configured to detect at least two simultaneous touches on the display (4).

5. The machine tool as claimed in claim 1, wherein the machine part (2) has two elements which can move relative to one another, and the drive unit (3) is configured to trigger relative movement of the elements toward one another by the swiping gesture which executes at least two simultaneous touches on the display (4).

6. The machine tool as claimed in claim 1, wherein the machine part (2) is adjustable in at least two axes, with the drive unit (3) being configured for separate adjustment in the at least two axes by different swiping movements which each trace one axis of the at least two axes on the display (4).

7. The machine tool as claimed in claim 1, wherein the drive unit (3) is configured to calculate a correctly positioned illustration of an instantaneous state of the machine part (2) based on a measurement signal from at least one sensor (9).

8. A method for driving a machine part (2) that is adjustable by a motor using a touch-sensitive display (4), comprising displaying the machine part (2) on the touch-sensitive display (4) in an instantaneous state of the machine part on a machine tool, and adjusting a position using the motor by executing a swiping gesture on the touch-sensitive display (4).

9. The method as claimed in claim 8, further comprising setting a speed of an adjustment movement depending on a speed of a detected swiping gesture.

10. The method as claimed in claim 8, wherein the machine part (2) has two elements which can move relative to one another, the method further comprising triggering a relative movement of the elements toward one another by the swiping gesture which executes at least two simultaneous touches on the display (4).

11. The method as claimed in claim 8, further comprising selecting the machine part (2) which is intended to be adjusted by selecting the illustrated machine part (2) on the display (4).

12. The method as claimed in claim 8, wherein the machine part (2) is adjusted in at least two axes separately from one another by means of different swiping movements which each trace one axis of the at least two axes on the display (4).

13. The method as claimed in claim 8, further comprising detecting the instantaneous state of the machine part using at least one sensor (9).
